(19) United States
(12) Patent Application Publication
(10) Pub. No.: US 2018/0081629 A1
(43) Pub. Date: Mar. 22, 2018

(54) METHOD AND APPARATUS FOR PROVIDING ORDERED SETS OF ARBITRARY PERCENTILE ESTIMATES FOR VARYING TIMESPANS

(71) Applicant: SevOne, Inc., Boston, MA (US)

(72) Inventors: William Kuhhirte, Redington Shores, FL (US); Yue Qiu, Chadds Ford, PA (US); Sean O'loughlin, Landenberg, PA (US)

(21) Appl. No.: 15/705,524

(22) Filed: Sep. 15, 2017

Related U.S. Application Data
(60) Provisional application No. 62/395,629, filed on Sep. 16, 2016.

(51) Int. Cl. G06F 7/24; G06F 17/30

(52) U.S. Cl. CPC G06F 7/24; G06F 17/30545

(57) ABSTRACT

A method includes interpreting a number of distributed data sets including resource utilization values corresponding to a plurality of distributed hardware resources, creating an approximation of a number of distributions corresponding to the distributed data set, aggregating the created approximations, and the aggregating includes weighting values determined from each of the distributed data sets, such that the aggregated approximations are representative of the distributed data sets. The method further includes creating a number of polynomial terms in response to the created approximations, thereby providing a utilization profile, and solving for a utilization percentile value within the aggregated approximations, where the solving is performed without reference to the distributed data set.

### CROSS REFERENCE TO RELATED APPLICATIONS

This application claims the benefit of U.S. Provisional Application No. 62/395,629, filed 16 Sep. 2016, entitled “METHOD AND APPARATUS FOR PROVIDING ORDERED SETS OF ARBITRARY PERCENTILE ESTIMATES FOR VARYING TIMESPANS”, the entirety of which is incorporated herein by reference for all purposes.

### FIELD

The methods and systems disclosed herein generally relate to the field of the analysis and optimization of data networks and distributed computer architecture.

### BACKGROUND

Traditional techniques for monitoring, analyzing, and reporting on the function of computer networks require extensive data pre-processing, aggregation, normalization and related steps to allow for an analyst to compute a percentile estimate. With the rise of cloud computing, and more generally the use of distributed computing networks, whether they are on-premise to an enterprise or distributed outside of an enterprise, efficiently accessing and processing the distributed data inherent to these computing platforms requires new analytic methods and systems. Measurement errors frequently occur, for example reporting utilization of the system in excess of 100%, or less than 0%, due to transcription errors, or some other type of error. Percentile selection enables the exclusion of outlying data that may be erroneous. As distributed systems, such as data centers, increase in scale, issues such as identifying drivers of resource consumption become more critical so that unnecessary hardware components may be decommissioned or temporarily taken offline until their use is required, and therefore their resource consumption justified.

### SUMMARY

Provided herein are methods and systems of distributed data aggregation and processing, comprising querying distributed data sets, wherein at least a portion of the data within the distributed data sets is unbounded in time, creating an approximation of the distributions of each of the distributed data sets, aggregating the created approximations, creating a plurality of polynomial terms based on the created approximations, and utilizing the polynomial terms to solve for a percentile value within the aggregation, wherein the raw data on which the aggregations are based is not utilized.

In embodiments, distributed data sets may be combined based at least in part by using the weighted means associated with each data set. The created approximations may in part be used to store a plurality of time interval data.

In embodiments, solving for the percentile value may facilitate identification of at least one infrequently used physical system in a data center. The identification of the at least one infrequently used physical system in a data center may be reported through a graphical user interface as an inactive physical system that may be deactivated to improve data center capacity. An infrequently used physical system may be a server, data repository, router, or some other hardware component.

In embodiments, the improvement to the data center capacity may relate to a reduction in the cooling requirements, electrical power requirements, or some other aspect of the data center's resource consumption.

An example operation to aggregate and process distributed data, such as resource utilization data for at least one aspect of at least one hardware resource in a distributed computing system, includes an operation to query a distributed data set including at least a portion of the data within the distributed data set being unbounded in time, to create an approximation of at least one aspect of the distributed data, to aggregate the approximation, to create a polynomial term in response to the approximation, and to utilize the polynomial term(s) to solve for a percentile value within the aggregation. In certain embodiments, the percentile value is created without reference to raw data from the distributed data set.

Certain further operations to aggregate and process distributed data are described herein, any one or more of which may be utilized in certain embodiments of the present disclosure. Example operations include combining the distributed data sets in response to a weighted mean associated with each one of a number of data sets included in the distributed data; wherein the approximations are utilized to store time interval data; identifying at least one physical system in a data center having one of low utilization and/or infrequent utilization in response to the percentile value; where the at least one physical system in the data center includes at least one of a server, a router, and/or a processor; deactivating at least one physical system in a data center in response to the physical system having the low utilization and/or infrequent utilization; where the deactivating provides for at least one of reducing cooling requirements of the data center and/or reducing power requirements of the data center; where at least one of the polynomial term(s) have an order of two; where at least one of the polynomial term(s) have an order of three; and/or where the approximation provides for an accuracy of within one-percent of the approximated aspect of the distributed data. An example operation includes determining a plurality of the percentile values within the aggregation utilizing a single pass of calculations utilizing the polynomial term(s).

These and other systems, methods, objects, features, and advantages of the present disclosure will be apparent to those skilled in the art from the following detailed description of the preferred embodiment and the drawings. All documents mentioned herein are hereby incorporated in their entirety by reference.

### BRIEF DESCRIPTION OF THE FIGURES

The accompanying figures and the detailed description below are incorporated in and form part of the specification, serving to further illustrate various embodiments and to explain various principles and advantages in accordance with the systems and methods disclosed herein.

FIG. 1 is a schematic depiction of operations for identifying a computing percentile and identifying a resource that may be taken offline to conserve data center resources.

FIG. 2 is a schematic depiction of operations for identifying a computing percentile, where raw data inputs are provided to a raw data storage facility, and identifying a resource that may be taken offline to conserve data center resources.

FIG. 3 is a schematic block diagram of an apparatus for identifying under-utilized and/or over-utilized resources in a distributed system.

FIG. 4 is a schematic flow diagram depicting operations to determine resource utilization percentile values.

FIG. 5 is a schematic flow diagram depicting operations to identify under-utilized and/or over-utilized resources in a distributed system.

FIG. 6 is a schematic flow diagram depicting operations to provide identified resources to a graphical user interface (GUI).

FIG. 7 is a schematic flow diagram depicting operations to reduce a power consumption of a distributed system.

FIG. 8 is a schematic flow diagram depicting operations to reduce system cooling requirements of a distributed system.

FIG. 9 is a schematic flow diagram depicting operations to identify replacement resources within a distributed system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the systems and methods disclosed herein.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detailed embodiments that are in accordance with the systems and methods disclosed herein, it should be observed that the embodiments reside primarily in combinations of method steps and/or system components related to providing accurate high capability utilization information, rapidly and with low consumption of resources (time, system bandwidth, processing, and/or memory). Accordingly, the system components and method steps have been represented where appropriate by conventional symbols in the drawings, showing only those specific details that are pertinent to understanding the embodiments of the systems and methods disclosed herein so as not to obscure the disclosure with details that will be readily apparent to those of ordinary skill in the art having the benefit of the description herein.

Disclosed herein are systems and methods for providing accurate (e.g., within <1% error) estimations of nth percentiles for a number of time intervals that may be provided to a user in an on-demand manner, such as real-time processing, without extensive data pre-processing, aggregation, normalization, and so forth, being required to allow the percentile estimate. With the rise of cloud computing and more generally the use of distributed computing networks, whether they are on-premise to an enterprise or distributed outside of an enterprise, efficiently accessing and processing the distributed data inherent to these computing platforms requires new analytic methods and systems.

Data that is distributed across a cloud or distributed computing environment may acquire network latency, making the formation of a centralized datastore prohibitively expensive to create and manage. Further, the distributed data is not a static dataset, but rather is a dynamic data set over time, continually being added to, revised, and so forth. This adds additional complexity to any attempts to create a centralized datastore; no sooner would such a centralized datastore be created than it is out of date, lacking the data that was populated in the various data nodes of the distributed computing environment after the creation of the centralized datastore. A constraint to a time bound data set can result in a limited data set (e.g., only a small amount of data for a specific time bound data set may be available for all applicable devices), increased memory requirements (e.g., storing excessive data for all devices ensuring that a minimum amount of data across a time interval is retained), and/or require the use of out-of-date data (e.g., a time interval may have to be selected that is significantly dated to ensure that data is available for all applicable devices). Accordingly, the present disclosure has recognized that the utilization of data that is not bound to a particular time interval can improve the system response and reduce resource consumption to support operations to determine resource utilization for a distributed system.

A key function and utility of aggregated data is reporting. Traditionally, reporting involves data pre-processing and “cleaning,” for example to remove incomplete or inaccurate data, field selection to determine the subset of data to analyze, standardization/normalization to obtain a dataset bearing needed characteristics for analysis (e.g., distribution type), and so forth. Such steps in the context of a distributed data storage and/or computing environment may be impractical, inefficient, or not possible. For example, inefficiencies may have several different forms. One type of inefficiency is that percentiles cannot be recombined. In an example, if one assumes that there are two data sets that each represent one hour of data on the same measurement (e.g., processor utilization, memory utilization for any type of memory, communication and/or network bandwidth utilization, etc.), the 95th percentile of a two-hour aggregate cannot be derived from the 95th percentiles of each one-hour block. As a result, to obtain an accurate percentile requires that an analyzing operation work with the raw data, which requires an increased number of calculation cycles (e.g., processor utilization), memory utilization, communication and/or network bandwidth, and time to completion. A second type of inefficiency may be derived from the first inefficiency in terms of financial cost, in that working with the raw data is expensive in terms of I/O costs as well as computation cost. If the system is a large distributed data set, the network latency and time of transmission to a centralized point is increases costs and operational impacts. It is more efficient to store such data in a digest form that (unlike compression) will remain a fixed size regardless of the size of the data set it represents. A third type of inefficiency may come as a result of the digest form in that a digest is not inherently sortable. Thus, to obtain an ordered list of all of the possible metrics, or of any arbitrarily selected metric, would require increased computational and I/O costs, for example an analyst would have to retrieve the entire digest for each potential entry, obtain the result in question and discard a high percentage of candidates. In a usage example, a user may request a report for an ordered list of values where the ordered value may be of an nth percentile of a given dataset. If the data on which this ordered list request is based is distributed, and were such data treated as if it were raw data in a centralized datastore, it would be prohibitively expensive to process the request, and may have further technical impediments based on the distributed architecture in which the data resides. An analyst may attempt to make this ordered list report, based on an nth percentile of a dataset, using for example a mathematical technique of converting the standard deviation of the dataset to a cumulative distribution function (CDF) which may then be inverted to select a specific percentile. However, this technique is only operable if the distribution of the data within the dataset is a known and well behaved type of distribution, such as a normal, or Gaussian, distribution.

Such simplicity as centralized, normally distributed datasets is not typical for distributed computing environments, and current techniques are not sufficient to provide a mechanism of producing reasonably accurate (<1% error) estimations of nth percentiles for arbitrary time intervals, and that may be rapidly ordered and/or filtered. Rapid ordering is a requirement in the distributed computing context because, unlike in a simple, centralized, relational database example, a distributed computing environment may include many thousands of data clusters, each residing in a computing environment that may be subject to its own rules as regards frequency update, purge, aggregation, and so forth. In a given cluster, there may be potentially millions of different datasets that need to be filtered and ordered based on a given criteria. Ideally, an analyst does not want to artificially constrain the time interval that the filtering and ordering may be applied to. In practice this may allow an analyst to combine data sets of different sizes freely. For example, if an analyst intended to provide a histogram for a time period covering the last 8 days, she could collect the last 192 hour aggregations, or the last 16 six-hourly aggregations, or the last 8 daily aggregations, and so forth, but the most efficient way (assuming storage of the data on traditional disk) would be to fetch 8 daily aggregations from a columnar data store to reduce the disk seek times. If using a SSD where seek times are close to zero, then the most efficient solution would be to fetch the last week aggregation and an additional 1-day aggregation. Because it is unrealistic to expect the data sets to always be uniform in size, this approach allows for flexibility in terms of data storage. If one assumes that each time approximation takes the same space, then having to read fewer of them is considerably more efficient. In an embodiment of the present disclosure, this may be accomplished through a two-phase process: 1) approximations of the distributions of the distributed datasets may be created that may be subsequently aggregated without a significant loss of accuracy; and 2) the distributions may be converted to a collection of polynomial terms that may be solved inline for a given percentile and used to sort the returned data.

Current solutions, such as those found in the financial services industry, allow for clustering approaches that may be used to approximate the distributions of large data sets. However, to meet an accuracy requirement (<1% error), an analyst needs between 0.5-1 times the number of samples buckets as the number of percentiles you want to compute. For example if one solves for nth percentiles where n is a whole number, between 50 and 100 samples will be required.

According the methods and systems of the present disclosure, techniques, including but not limited to k-means clustering, t-digest, and the like, may be used for creating groups of samples that collectively represent the distribution. In embodiments, a sample may have a median value and a set number of entries. A weighted mean may be used to combine multiple datasets together, thereby allowing the storage of larger sets of data without compromising accuracy since the number of samples in a group need not be linearly related to the size of the raw data entries. Such techniques may be used to store approximations for a plurality of granularity intervals (e.g., hourly, six-hourly, daily, weekly, monthly, and so forth) giving an accurate representation, improving computing efficiency (e.g., because data size has been reduced) and decreasing storage costs for the data. Continuing the example, a polynomial curve fitting approach may be used and the polynomial terms stored in a database. This may allow solving for a particular percentile value and order the results without either retrieving the raw data, nor using cluster approximations. Although solving in such a manner may result in a value that has inherent inaccuracies, solving in this manner may eliminate a significant portion of the potential results with minimal data retrieval required from the distributed computing architecture, and this in turn may speed processing time, reduce costs, or have other advantages based on the reduced computations inherent in the methods and systems of the present disclosure. For example, the dataset resulting from the use of such techniques may be several orders of magnitude smaller than the list of potential candidates. Once the result set is obtained, the data cluster results may be individually re-aggregated, as described herein, using multiple granularity groupings to match the requested time interval and then re-order the final result. Thus, it is not a requirement to filter many of those sets by other criteria or to sort them in a lexical order rapidly.

In another embodiment of the present disclosure, the methods and systems described herein may perform percentile calculations but do so by, for example: 1) providing a fixed set of percentiles that are pre-calculated (e.g., 90^{th}, 95^{th}, 99^{th}, etc.); and 2) examining the raw data and computing the percentile from the raw data.

In an example embodiment of the use of TopN percentiles methods and systems, as described herein, are applied within a two-pass system. For some customers, connections from various service providers may have a fixed capacity and an upgrade process that can take weeks or months depending on the infrastructure that needs to change. For example issues may include, but are not limited to, the fact that the media used may not support the desired speed, there may be a lack of port availability on the provide side, there may be scheduling issues, and so forth. Typically, these values are measured at interfaces that terminate the connections. By looking at the utilization locations of those interfaces relative to the capacity of the connection, it may be possible to determine when certain connections will run out of capacity, enabling the customer to order any upgrades of those connections with sufficient lead time to ensure service continuity. In embodiments, interfaces may represent a significant portion of the elements being managed, with hundreds of thousands, or not millions, of interfaces being managed. Thus, even though a manager responsible for capacity planning in such an environment may only need to worry about tens or hundreds of a total number of interfaces in any given week, the data set that may need to be examined may be very large.

One issue encountered with estimation of future behavior and network performance is determining an historical pattern that can be used to predict future behavior. Any data set that is large enough is likely to have outliers or some type of anomalous data. These data types may be the result of measurement errors, behavioral inconsistencies, and/or other conditions that do not represent normal behavioral pattern or performance. Using percentiles (such as 95^{th} and 99^{th} percentiles) eliminates outliers or abnormal data, and provide for computing a better prediction of future values. For comparison, an analyst may not use a peak value as it may not have the same slope as the average value. An analyst may also not use the average value since the service will already be impaired when the average value reaches 100% utilization. Thus, in one example, the 95^{th} percentile (˜2 standard deviations from the norm) gives an analyst a better estimation of when the “real peak” will cross an applicable threshold, and using the 99^{th} percentile (˜3 standard deviations) is even more accurate. Depending on the accuracy required and the desired lead time for responding to capacity limitations—since upgrading a connection costs real money and some systems may be linked to service level agreements (SLAs) or other uptime requirements—thus, there is a tradeoff on which percentile provides “best” data for any given user. One of skill in the art, having the benefit of the present disclosure and information ordinarily available about the contemplated data set, usage history, and network performance, can readily determine appropriate values for the selected percentiles for a contemplated system.

In an example of the present disclosure, a TopN percentile analysis, as described herein, may be used to show a projection of the utilization of interfaces for a time period, such as the next month, based on a selected percentile (e.g., between 90^{th} and 99^{th} percentile, between 68^{th} and 99.7^{th} percentile, and/or a selected number of standard deviations such as 1, 2, 3, 4, and inclusive ranges therebetween) and sorting the results based on, for example, the number of days before the projection crosses 100% utilization of the connection capacity. By using a two-pass system, as described herein, it is possible to eliminate a significant percentage of the candidate interfaces needed for the report inline in the database query and then obtain for the remainder a digest view of a histogram to provide accurate projections while still needing less data (and thus being faster, utilizing fewer processing cycles, and/or lower memory utilization) than using the raw data. In an example, the calculation may be expressed as a formula, which can be solved easily for each row. This may allow an analyst to use the database query itself as a filter of the relevant data sets. However, this calculation is likely not as accurate as it would be if the raw data were used. Typically, an analyst would obtain two times the result limit of the report and then proceed to the next step. This number of results is generally several orders of magnitude less than the total number of candidates available. For example, a system may have several million Interface objects and an analyst may be searching for the top 1000 entries that will be closest to 100% utilization in the next month. Thus, once the analyst has eliminated a significant portion of the samples, she can then reference the digest form of the data to provide accurate results. This may ensure the real TopN entries are presented as well as ensure a consistent order.

In an example of the present disclosure, data center machines to be retired may be identified using the TopN percentile methods as described herein. One of the main capacity limitations in a data center is the availability of power and cooling. The TopN percentile methods may be used to identify the least used physical systems in a data center and schedule them to be removed or recycled. This is essentially a “BottomN” report. An analyst may not use a minimum value for things like system load since, for example, systems will experience some time periods being powered off, under maintenance, or have some other issue where utilization registers as zero. For example, a 5^{th} percentile report can be used to discard those values and focus on normal operations. Such TopN techniques may also be used to determine the least used systems over the last month, or some other time period, discarding the natural outliers and giving a better picture of real utilization. Example markets in which the techniques described herein may include, but are not limited to, business intelligence, sales and marketing, housing, or some other type of market requiring analytics.

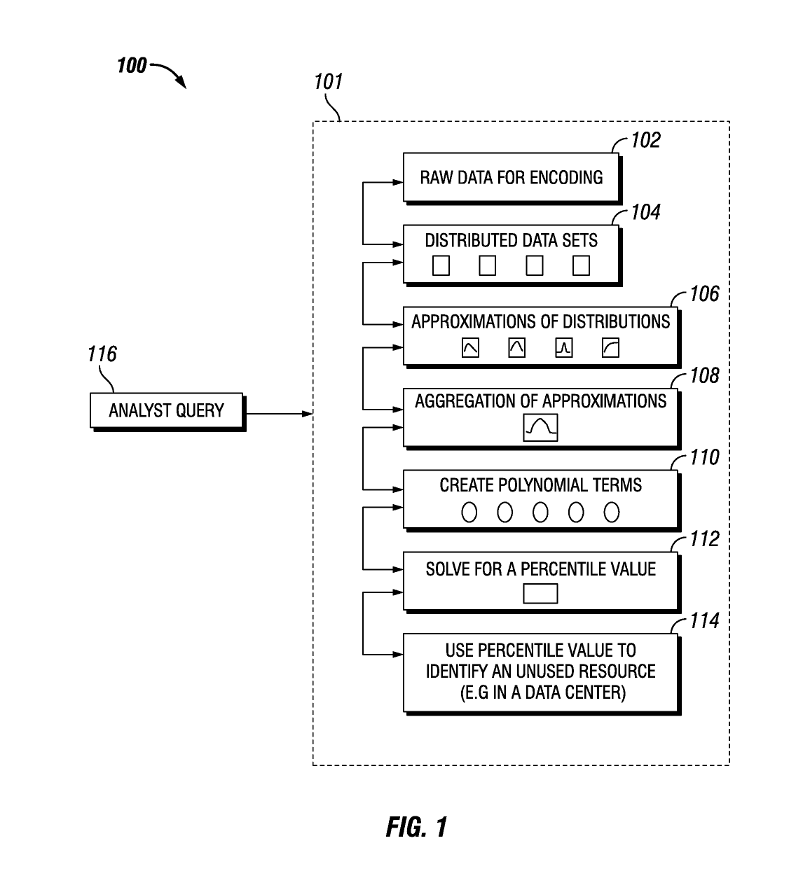

Referring to FIG. 1, an example system 100 depicts operations to identify unused, under-utilized, and/or over-utilized resources (e.g., identified resources 114). In one example, an analyst provides a query 116 of a number of data sets 104 within a distributed computing architecture, such as a cloud computing environment. In the example, the query 116 is provided to a controller 101 having the raw data 102 thereupon, although the controller 101 may be in communication with devices having the data, and/or may retrieve the data in response to the query 116. The example system 100 includes the query 116 provided to the controller 101, although the query 116, in certain embodiments, may be created on or created by the controller 101. The controller 101 is provided as an example device, and may be a distributed device and/or a part of the distributed computing system. The example raw data 102 includes resource utilization information for a distributed computing system (not shown), such as but not limited to processor utilization, memory utilization (e.g. RAM, disk memory, or other memory types), and/or communication or network bandwidth utilization.

The example system 100 includes the controller 101 creating the distributed data 104 from the raw data 102, although the controller 101 may receive the distributed data 104 directly. The distributed data 104 includes utilization data corresponding to devices in the distributed system, and/or may include data distributed over time or in other dimensions of interest for analysis. In certain embodiments, the distributed data 104 is not bounded in time, for example data for various devices in the distributed system may be taken as available without being bound to particular ranges of time values. The example controller 101 creates approximations 106 of each data set in the distributed data 104.

The example controller 101 aggregates the approximations 106 to create a single aggregated approximation 108 of the data distribution inherent in the distributed data sets 104. The example controller 101 provides polynomial terms 110, based at least in part on the aggregated approximation 108. The polynomial terms 110 allow for the rapid solving of a specified percentile value 112. This percentile value may represent, in an example, the hardware resources of one or more networks that are the least active within the distributed system. The controller 101 utilizes the percentile values 112 to provide identified resources 114, such as unused resources, under-utilized resources, resources operating at capacity, and/or resources operating near-capacity. In certain embodiments, the controller 101 provides for a mechanism to identify resources that can be decommissioned, taken offline, that require upgrades or added parallel capacity, and/or to identify resources within the distributed system that can provide replacement capacity for other resources to allow them to be taken offline, replaced, upgraded, or the like. In certain embodiments, resources may be taken offline or decommissioned to reduce power consumption by one or more aspects of the distributed system, to reduce a cooling requirement for one or more aspects of the distributed system, and/or to allow for intermittent operations to one or more aspects of the distributed system such as system upgrades or maintenance.

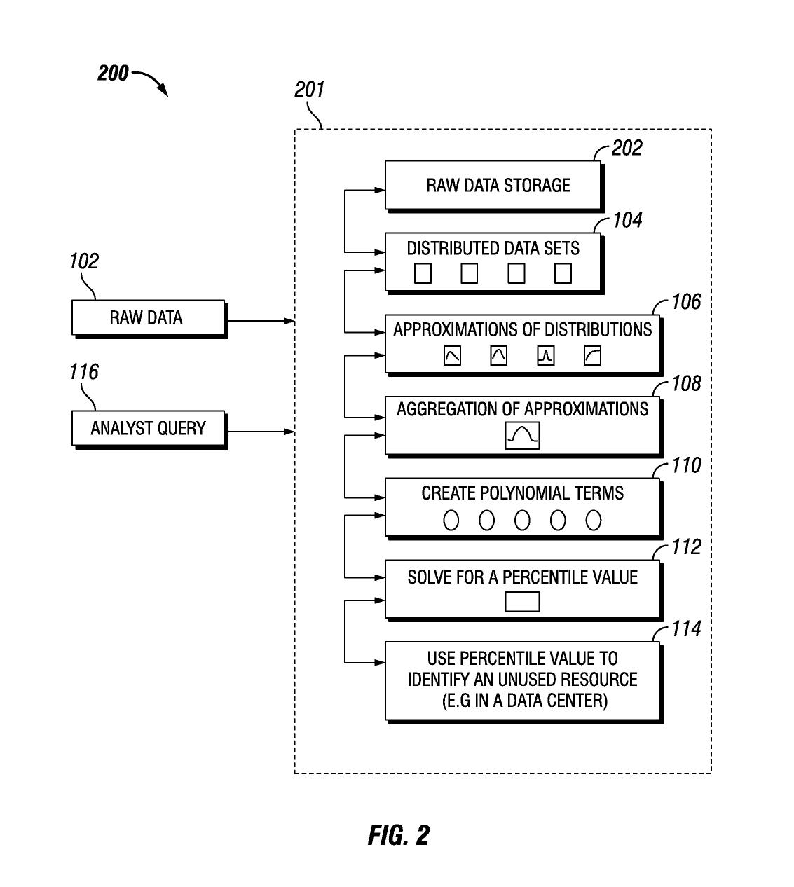

Referencing FIG. 2, an example system 200 includes an analytic controller 201, with the raw data 102 communicated to the analytic controller 201, and an analyst providing the analyst query 116 to the analytic controller 201. The example analytic controller 201 includes raw data storage 202 for use in processing the analyst query 116. For example, raw data 102 sent may be subsequently accessed from the raw data storage 202 facility for the creation of distributed data sets 104, or some other analytic step performed in response to the analyst query 116.

In embodiments of the present disclosure, the methods and systems described herein may be used to provide generalized piecewise-parabolic streaming estimation for percentiles. Traditionally, percentile computation has used techniques such as the P-square algorithm (hereinafter referred to as the “P2 algorithm” or “P2”). Although the P2 algorithm improved on prior techniques in ways, it has inherent disadvantages, including but not limited to:
The P2 algorithm requires specifying the percentiles of interest.
Multiple summaries may not be combined. For example, using the P2 algorithm, percentiles may be estimated through a set of relevant markers, and these markers may need to be maintained throughout the entire process of data processing. One benefit of using markers is that it requires less maintenance, both in terms of memory and computation utilization. However, markers may contain less information than traditional summaries and thus have distinct statistical properties relative to the whole dataset (e.g., traditional summaries may include different statistical properties of the whole dataset).
Histogram creation requires specifying how many groupings are wanted.
For traditional summaries, one may have information such as the number of points around a certain centroid (cluster center). This may be used to calculate different percentiles after the summary is formed (e.g., by combining the number of points around centroid). Further, different summaries may be easier to combine because the centroids in different summaries are equivalent in usage. For the P2 algorithm, the markers may be created to fit a particular use case, and may be a more targeted use of the data. This may require less memory and computation utilization based at least in part on the fact that it doesn't create a summary for the whole dataset, but instead creates a “summary” (or marker) for a specific percentile.

In an example of the application of the P2 algorithm, if the goal were to solve to find percentiles for 0.50, 0.90, 0.95, and 0.99, the P2 algorithm would allow the analyst to proceed in one of two ways:

Run calculations four times: For each calculation the analyst must determine the number for each percentile of interest (the analyst may save an extra state, such as a minimum and maximum, since it will be the same across all percentile calculations). Thus, for each percentile the analyst will need three specified states (the percentile, mid-point between minimum (MIN), mid-point between maximum (MAX)), plus MIN and MAX.

Use a histogram: Configuring a histogram may require considerable pre-planning and effort, and may be an error-prone process. After a histogram is configured and data is collected, there are often extra steps required for post-processing to get the needed percentile. A histogram is essentially building an elementary summary of the entire dataset, and requires more resources than using the P2 algorithm. Furthermore, based on the accuracy requirement, for a standalone histogram to solve the percentile problem, the number of bins may vary. For example, with 100 points and an analyst query for a 95th percentile with 1 percent of error-bound, 100 bins may be sufficient to reach the goal. If the number of points changed from 100 to 100 million, 100 bins would not meet the requirement, as the resource requirement increases with the dataset. If an analyst uses a histogram as the filter stage for what the P2 algorithm offers, it will also consume more resources, and with limited benefits. Therefore, an algorithm with lower resource requirements is desirable.

In embodiments of the present disclosure, the methods and systems of the generalized piecewise-parabolic streaming estimation (“Generalized P2”) for percentiles may be used for at least the following objectives:
Percentile estimation with less interaction with database including the raw data 102 and/or the distributed data sets 104, and that does not require a large amount of computation power and memory usage, thereby obtaining an estimation in a timely manner, with reduced processor utilization, memory utilization, and that is not sensitive to communication of large data sets within a distributed communicating environment.
Improve and/or optimize the memory and computation process to achieve better accuracy, and to create a one-pass estimator of a selected percentile value, rather than requiring multiple calculation runs.

In an example, for the Generalized P2, an analyst may follow a process, including but not limited to, that described below:
Gather the target percentiles (e.g., 0.50, 0.90, 0.95, 0.99), and calculate the mid-point between min for the smallest percentile, midpoint between max for the largest percentile, resulting in, for the example: 0.25, 0.50, 0.90, 0.95, 0.99, 0.995.
Next, instead of using the exact half point to calculate the percentile, the analyst may use adjacent percentiles to estimate. In this example:
   0.50 is estimated by 0.25 and 0.90 instead of 0.25 and 0.75
   0.90 is estimated by 0.50 and 0.95 instead of 0.45 and 0.95
   0.95 is estimated by 0.90 and 0.99 instead of 0.475 and 0.975
   0.99 is estimated by 0.95 and 0.995 instead of 0.5 and 0.995

Continuing the example, note that the use of the original P2 algorithm would have required four passes (or four parallel runs) to calculate four percentiles, while keeping 20 states. With a direct optimization of the P2 algorithm, keeping 14 states for calculating 4 percentiles are achievable, but still requiring four passes. The number of states for calculating N percentiles is: 3N+2 (direct optimized P2) or 5N (un-optimized P2). However, by utilizing the Generalized P2 algorithm according to the methods and systems as described herein, it is possible to make a single pass to calculate four percentiles, keeping eight states in total. Thus, the number of states for calculating N percentiles using Generalized P2 is: N+4. It can be seen that the benefits for the Generalized P2 increase as a greater number of percentile values 112 are utilized in the system. In summary, some of the advantages of the Generalized P2 over traditional methods and systems, include but are not limited to:
The number of states required to maintain is smaller than the original P2 algorithm.
The accuracy of Generalized P2 is comparable to, or better than, P2.

In embodiments of the present disclosure, P2 techniques may be used to initially sort and assist in the determination of the estimators of actual percentiles. For example, if an analyst wants to select the top 100 indicators, then one may select the top 150 or 200 indicator IDs that are sorted using the P2 techniques, filtering the raw data down to the top 150 or 200 indicator IDs (e.g., by querying the raw data 102 for just those indicators) to obtain the raw values. Raw values may then be used to perform percentile calculations. Thus, accuracy for the top indicators is ensured, while the number of processing cycles and system memory requirements are greatly reduced.

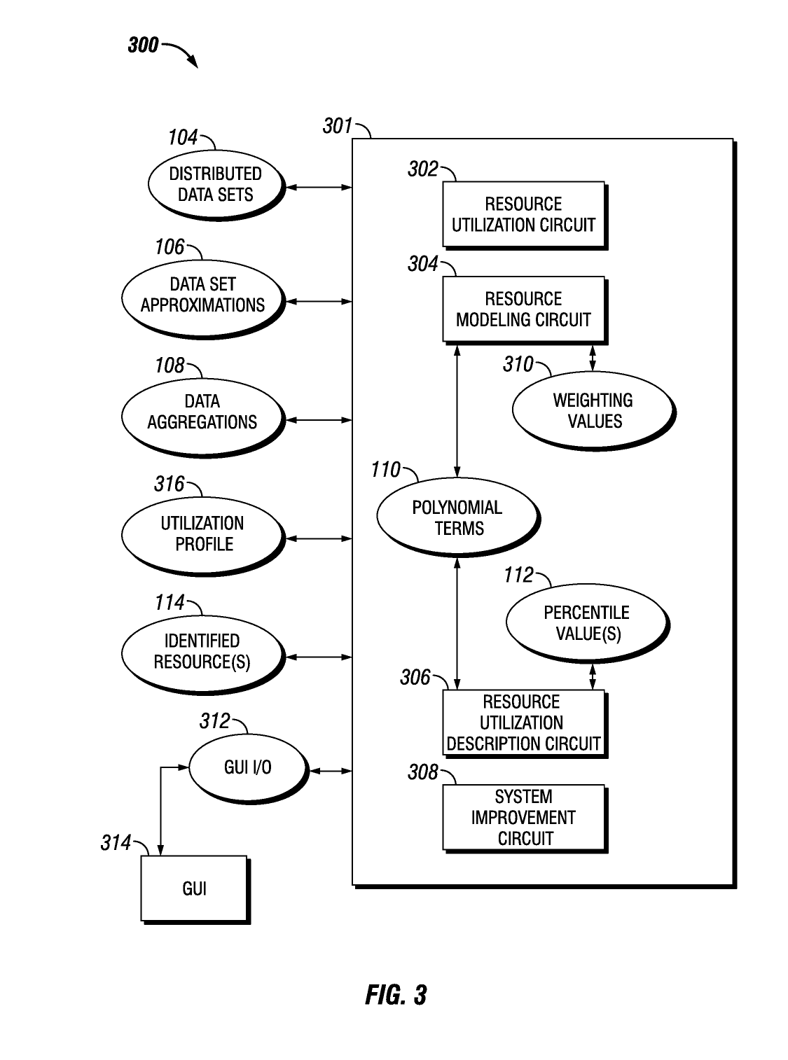

Referencing FIG. 3, an example apparatus 300 includes a controller 301 including a number of circuits structured to functionally perform operations of the controller 301. Example and non-limiting circuits include memory, processors, and/or computer readable instructions configured to perform certain operations of the controller 301. Example circuits further include network communication devices, input and/or output devices, and interfaces to the distributed system including hardware resources to be analyzed for resource utilization and/or interfaces to a user. The controller 301 depicts one logical grouping of components, but aspects of the controller 301 may be distributed among several devices and/or included with one or more other devices, such as hardware resources forming a part of the distributed system to be analyzed.

In certain embodiments, the controller 301 includes a resource utilization circuit 302 that interprets a number of distributed data sets 104. The example distributed data sets 104 include resource utilization values corresponding to a number of distributed hardware resources. An example resource utilization circuit 302 takes data directly from the distributed system (not shown), for example updating the distributed data sets 104 at intervals through direct communication with the distributed system. Additionally or alternatively, the distributed data sets 104 are passed to the controller 301 directly, for example during operations by an analyst (not shown) contemplating a particular distributed system and having the distributed data sets 104 available. In certain embodiments, the resource utilization circuit 302 creates the distributed data sets 104, such as from raw data 102 communicated to the resource utilization circuit 302 and/or stored on the controller 301.

The example controller 301 further includes a resource modeling circuit 304 that creates approximations 106 of the distributed data sets 104, and further aggregates the approximations (e.g., as data aggregations 108). The example resource modeling circuit 304 further provides polynomial terms 110 in response to the aggregated approximations 108, thereby providing a utilization profile 316. The utilization profile 316 allows for the rapid determination of selected percentile values 112 within hardware devices of the distributed system, for example according to a Generalized P2 algorithm. The example controller 301 further includes a resource utilization description circuit 306 that solves for a utilization percentile value 112 within the aggregated approximations 108. An example resource utilization description circuit 306 additionally solves for the utilization percentile value(s) 112 without reference to either the raw data 102 or the distributed data sets 104.

An example resource modeling circuit 304 further creates the data aggregations 108 by providing weighting values 310 determined from each of the distributed data sets 104, such that the aggregated approximations 108 are representative of the distributed data sets 104. For example, the weighting values 310 allow for direct utilization of distributed data sets 104 of different sizes, time ranges, etc. An example apparatus 300 includes at least some, or all, of the distributed data sets 104 being unbounded in time. In certain embodiments, the created approximations 106 include a number of time interval data values.

An example resource utilization description circuit 306 performs filtering and/or sorting of at least a portion of the distributed hardware resources in response to the percentile values 112. For example, a resource utilization description circuit 306 filters and/or sorts distributed hardware resources corresponding to the distributed data sets 104 according to the percentile values 112, and performs one of: displaying a portion of the sorted distributed hardware resources to a user (e.g., through GUI 314), filtering a portion of the sorted distributed hardware resources and obtaining the distributed data sets 104 and/or raw data 102 only for the filtered portion of the sorted distributed hardware resources. Operations of the controller 301 to the GUI 314 may be provided through a GUI I/O 312 (e.g., communications passed over a network to the GUI), and/or in certain embodiments the controller 301 may include the GUI 314 where the user interacts directly with the controller 301. In certain embodiments, the GUI 314 may be operated on a computer directly associated with the user. Additionally or alternatively, the GUI 314 may include an interactive web page hosted on, or in communication with, the controller 301. It can be seen that the filtering and/or sorting of at least a portion of the distributed hardware resources can enable more accurate utilization of the distributed data sets 104 and/or raw data 102 by reducing the amount of data to be evaluated thereby, and/or can provide a user with a convenient list of candidate resources for further processing or evaluation by the user.

An example controller 301 includes a system improvement circuit 308 that identifies at least one of an infrequently utilized or an under-utilized one of the distributed hardware resources in response to the utilization percentile value(s) 112. An example apparatus 300 further includes a means for reducing a power consumption of the distributed system including the distributed hardware resources. Without limitation to any other aspect of the present disclosure, example and non-limiting means for reducing the power consumption of the distributed system include: providing a list of one or more unutilized and/or under-utilized resources to a user; providing a user with a selection option for one or more unutilized and/or under-utilized resources and powering down and/or taking offline the one or more unutilized and/or under-utilized resources in response to a user selection of the selection option; powering down and/or taking offline one or more of the unutilized and/or under-utilized resources in response to pre-determined criteria such as a percentile threshold (e.g., shut down resources below 1%) and/or in response to an availability of other resources to pick up the workload of the resources to be powered down or taken offline; and/or communicating the percentile values 112 to another device in the distributed system whereupon the other device determines to power down and/or take offline one or more resources in response to the percentile values 112. In certain embodiments, the means for reducing the power consumption further includes considering the geographic distribution of devices identified by the percentile values 112 (e.g., where it is determined that shutting down multiple devices in a single location provides for a greater power reduction, or a reduced power reduction, than shutting down the same number of devices across multiple locations), considering a local time or other power-relevant factors for specific devices in the distributed system (e.g., favoring shutting down devices where power is more expensive at a particular location), and/or shutting down devices to meet specific power requirements and/or thresholds for a location (e.g., shutting down devices in one location to bring it under a threshold power capacity value in favor of other similar percentile value 112 devices in another location that would not create such a benefit).

An example apparatus 300 includes a means for reducing a cooling requirement of a distributed system including the distributed hardware resources. Without limitation to any other aspect of the present disclosure, example and non-limiting means for reducing the cooling requirement of the distributed system include: providing a list of one or more unutilized and/or under-utilized resources to a user; providing a user with a selection option for one or more unutilized and/or under-utilized resources and powering down and/or taking offline the one or more unutilized and/or under-utilized resources in response to a user selection of the selection option; powering down and/or taking offline one or more of the unutilized and/or under-utilized resources in response to pre-determined criteria such as a percentile threshold (e.g., shut down resources below 1%) and/or in response to an availability of other resources to pick up the workload of the resources to be powered down or taken offline; and/or communicating the percentile values 112 to another device in the distributed system whereupon the other device determines to power down and/or take offline one or more resources in response to the percentile values 112. In certain embodiments, the means for reducing the cooling requirement further includes considering the geographic distribution of devices identified by the percentile values 112 (e.g., where it is determined that shutting down multiple devices in a single location provides for a greater cooling requirement reduction, or a reduced cooling requirement reduction, than shutting down the same number of devices across multiple locations), considering a local time or other cooling requirement-relevant factors for specific devices in the distributed system (e.g., favoring shutting down devices where cooling is more expensive at a particular location), and/or shutting down devices to meet specific cooling capacity requirements and/or thresholds for a location (e.g., shutting down devices in one location to bring it under a threshold cooling capacity value in favor of other similar percentile value 112 devices in another location that would not create such a benefit).

An example apparatus 300 includes a means for identifying a first number of the distributed hardware resources and a second number of the distributed hardware resources, where the first number of the distributed hardware resources includes sufficient replacement capacity for the second number of the distributed hardware resources. For example, the controller 301 may identify a first group of hardware devices having sufficient resource capacity that, if the second group of hardware devices is taken offline or powered down, the first group of hardware devices could compensate for the lost utilization from the second group of hardware devices. Accordingly, a user can schedule a maintenance event, an upgrade event, and/or quickly determine a replacement set of hardware in response to a scheduled or unscheduled loss of the second group of hardware devices. An example controller 301 may further interpret relationships among the hardware devices (e.g., some hardware devices may not provide sufficient functionality, be owned by the same entities, or have other constraints that limit them from replacing other hardware devices). An example controller 301 may further receive, for example through the GUI 314, a proposed set of devices from a user that the user is requesting to determine if the capacity for those devices can be readily replaced. For example, a user may select devices scheduled for a maintenance or upgrade event, and/or select devices for which a loss of service is scheduled or has occurred in an unscheduled manner (e.g., a natural disaster, power loss, or other event). Without limitation to any other aspect of the present disclosure, example and non-limiting means for identifying a first number of the distributed hardware resources and a second number of the distributed hardware resources, where the first number of the distributed hardware resources includes sufficient replacement capacity for the second number of the distributed hardware resources, includes the controller 301 receiving a proposed set of devices from a user, determining a proposed set of devices based on pre-determined criteria such as a percentile value 112 threshold, and/or based on device criteria such as model numbers, age of the devices, operating systems, or the like. An example means for identifying a first number of the distributed hardware resources and a second number of the distributed hardware resources, where the first number of the distributed hardware resources includes sufficient replacement capacity for the second number of the distributed hardware resources further includes determining a set of devices having sufficient replacement capacity, and providing the set of devices (including, optionally, more than one possible set of devices), to the user. In certain further embodiments, the controller 301 receives a selection from the user and responds by powering down or taking offline the proposed device(s) and/or communicating to the distributed system to power down or take offline the proposed device(s). In certain embodiments, the controller 301 provides a reduced set of the proposed devices to a user, for example if the user has requested 100 devices to be taken offline for upgrades, and the controller 301 determines that replacement capacity is available for only 80 of the devices, the example controller 301 communicates the reduced list of proposed devices to the user for further consideration.

The following descriptions reference schematic flow diagrams and schematic flow descriptions for certain procedures and operations according to the present disclosure. Any such procedures and operations may be utilized with and/or performed by any systems of the present disclosure, and with other procedures and operations described throughout the present disclosure. Any groupings and ordering of operations are for convenience and clarity of description, and operations described may be omitted, re-ordered, grouped, and/or divided unless explicitly indicated otherwise.

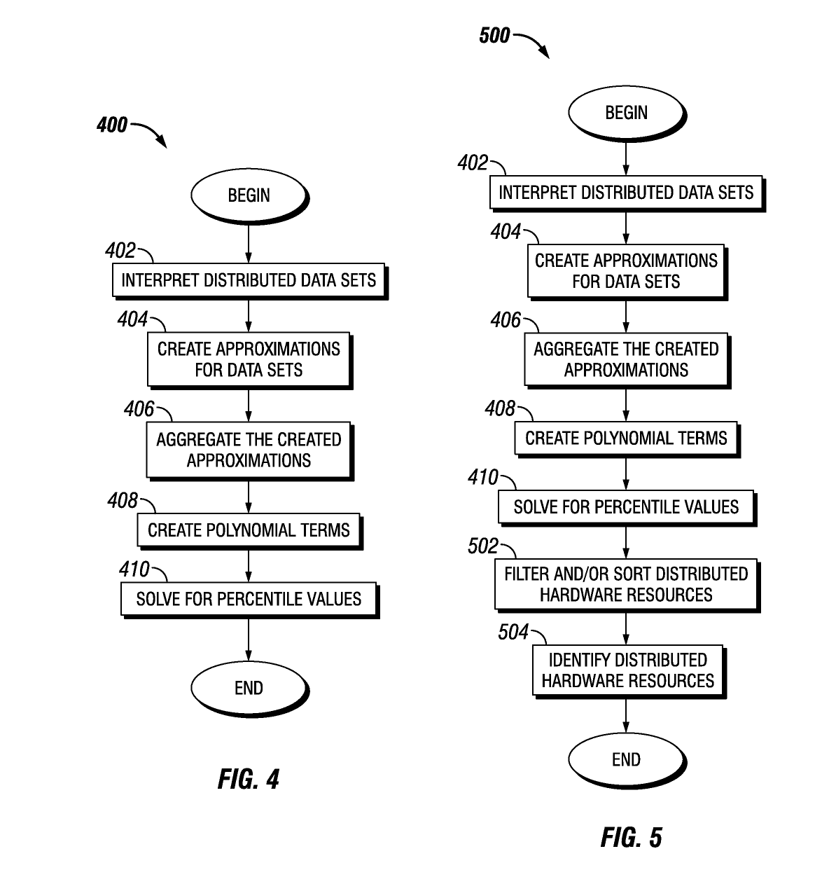

Referencing FIG. 4, an example procedure 400 for determining percentile values is depicted. The procedure 400 includes an operation 402 to interpret distributed data sets, an operation 404 to create approximations for the data sets, and an operation 406 to aggregate the created approximations. The example procedure 400 further includes an operation 408 to create polynomial terms in response to the aggregated approximations, and an operation 410 to solve for percentile values from the polynomial terms. Referencing FIG. 5, an example procedure 500 for identifying one or more distributed hardware resources is depicted. The example procedure 500, in addition to operations such as those depicted for procedure 400, includes an operation 502 to filter and/or sort distributed hardware resources based at least in part on the percentile values, and/or includes an operation 504 to identify distributed hardware resources based at least in part on the percentile values and/or the filtered or sorted distributed hardware resources of operation 502. Operations 504 to identify resources include identifying unutilized resources, under-utilized resources, resources at capacity, resources near capacity, and/or a replacement set of resources having sufficient capacity to make up for a second set of resources that are offline or are being considered to be taken offline. In certain embodiments, operation 504 is performed on a filtered or sorted set of the resources, and operation 504 is thereby performed on a reduced set of the raw data and/or the distributed data values. In certain embodiments, operation 504 is performed utilizing the percentile values determined in operation 410.

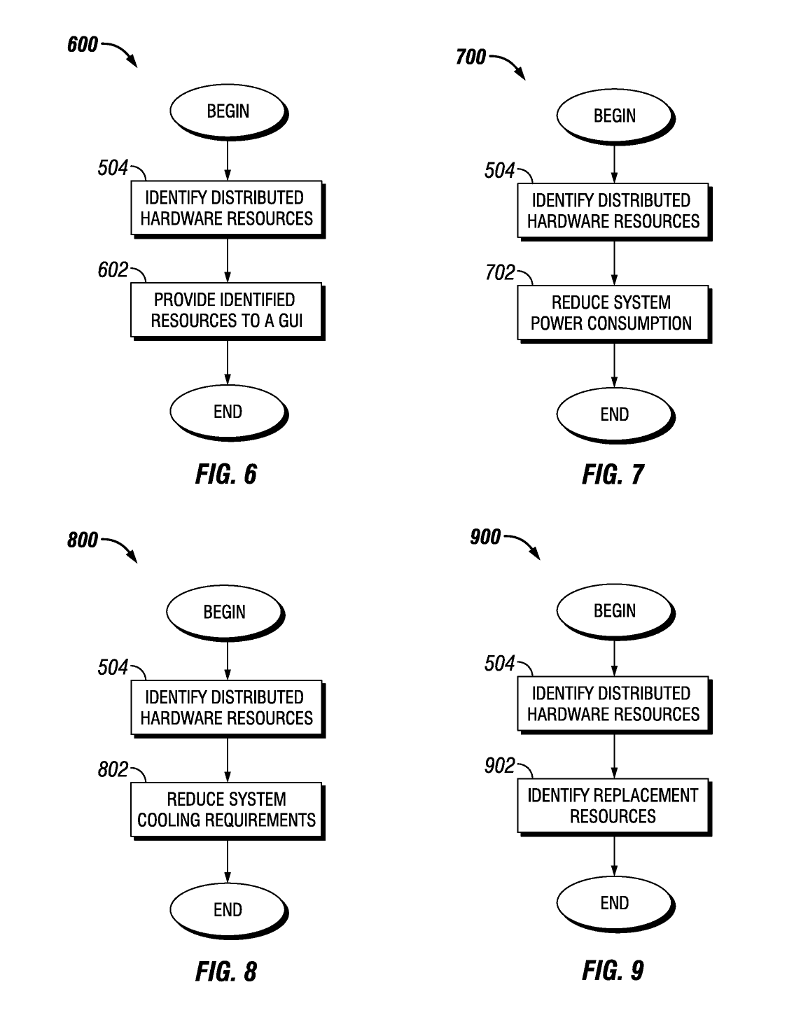

Referencing FIG. 6, a procedure 600 to provide identified resources to a GUI is depicted. Example procedure 600 includes the operation 504 to identify one or more resources, and an operation 602 to provide one or more of the identified resources to a GUI. Referencing FIG. 7, a procedure 700 to reduce system power consumption is depicted. Example procedure 700 includes the operation 504 to identify one or more resources, and an operation 702 to reduce power consumption for the distributed system in response to the identified resources. Referencing FIG. 8, a procedure 800 to reduce a system cooling requirement is depicted. Example procedure 800 includes the operation 504 to identify one or more resources, and an operation 802 to reduce a cooling requirement for the distributed system in response to the identified resources. Referencing FIG. 9, a procedure 900 to identify replacement resources is depicted. Example procedure 900 includes the operation 504 to identify one or more resources, and an operation 902 to identify replacement resources in response to the identified resources. An example operation 902 includes identifying a first number of the distributed hardware resources and a second number of the distributed hardware resources, where the first number of the distributed hardware resources includes sufficient replacement capacity for the second number of the distributed hardware resources.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A method, comprising:
interpreting a plurality of distributed data sets comprising resource utilization values corresponding to a plurality of distributed hardware resources;
creating an approximation of a plurality of distributions corresponding to the distributed data set;
aggregating the created approximations, wherein the aggregating comprises weighting values determined from each of the distributed data sets, such that the aggregated approximations are representative of the distributed data sets;
creating a plurality of polynomial terms in response to the created approximations, thereby providing a utilization profile; and
solving for a utilization percentile value within the aggregated approximations, wherein the solving is performed without reference to the distributed data set.

2. The method of claim 1, wherein at least a portion of the distributed data sets are unbounded in time.

3. The method of claim 2, wherein the created approximations include a plurality of time interval data values.

4. The method of claim 1, further comprising performing at least one of filtering and sorting at least a portion of the plurality of distributed hardware resources in response to the utilization percentile value.

5. The method of claim 1, further comprising identifying at least one of an infrequently utilized or an under-utilized one of the distributed hardware resources in response to the utilization percentile value.

6. The method of claim 5, further comprising providing the identified distributed hardware resource to a user through a graphical user interface.

7. The method of claim 5, wherein the identified distributed hardware resource comprises at least one of a server, a router, a processor, or a data repository.

8. An apparatus, comprising:
a resource utilization circuit structured to interpret a plurality of distributed data sets comprising resource utilization values corresponding to a plurality of distributed hardware resources;
a resource modeling circuit structured to:
create an approximation of a plurality of distributions corresponding to the distributed data set;
aggregate the created approximations;
create a plurality of polynomial terms in response to the aggregated approximations, thereby providing a utilization profile; and
a resource utilization description circuit structured to solve for a utilization percentile value within the aggregated approximations, and to perform the solving without reference to the distributed data set.

9. The apparatus of claim 8, wherein the resource modeling circuit is further structured to aggregate the created approximations by weighting values determined from each of the distributed data sets, such that the aggregated approximations are representative of the distributed data sets.

10. The apparatus of claim 8, wherein at least a portion of the distributed data sets are unbounded in time.

11. The apparatus of claim 10, wherein the created approximations include a plurality of time interval data values.

12. The apparatus of claim 8, wherein the resource utilization description circuit is further structured to perform at least one of filtering and sorting at least a portion of the plurality of distributed hardware resources in response to the utilization percentile value.

13. The apparatus of claim 8, further comprising a system improvement circuit structured to identify at least one of an infrequently utilized or an under-utilized one of the distributed hardware resources in response to the utilization percentile value.

14. The apparatus of claim 13, wherein the system improvement circuit is further structured to provide the identified distributed hardware resource to a user through a graphical interface.

15. The apparatus of claim 14, further comprising a means for reducing a power consumption of a distributed system including the plurality of distributed hardware resources.

16. The apparatus of 14, further comprising a means for reducing a cooling requirement of a distributed system including the plurality of distributed hardware resources.

17. The apparatus of 14, further comprising a means for identifying a first plurality of the distributed hardware resources and a second plurality of the distributed hardware resources, wherein the first plurality of the distributed hardware resources comprises sufficient replacement capacity for the second plurality of the distributed hardware resources.

18. A method, comprising:
interpreting a plurality of distributed data sets comprising resource utilization values corresponding to a plurality of distributed hardware resources;
creating an approximation of a plurality of distributions corresponding to the distributed data set;
aggregating the created approximations;
creating a plurality of polynomial terms in response to the created approximations, thereby providing a utilization profile; and
solving for a utilization percentile value within the aggregated approximations, wherein the solving is performed without reference to the distributed data set.

19. The method of claim 18, wherein the plurality of polynomial terms comprise an order of less than four.

20. The method of claim 19, wherein at least a first portion of the distributed data sets are unbounded in time.

21. The method of claim 20, wherein the created approximations include a plurality of time interval data values.

22. The method of claim 21, further comprising performing at least one of filtering and sorting at least a second portion of the plurality of distributed hardware resources in response to the utilization percentile value.

23. The method of claim 22, further comprising identifying at least one of an infrequently utilized or an under-utilized one of the distributed hardware resources in response to the utilization percentile value.

24. The method of claim 23, wherein the aggregating comprises weighting values determined from each of the distributed data sets, such that the aggregated approximations are representative of the distributed data sets.
